(19) United States
(12) Patent Application Publication
(10) Pub. No.: US 2024/0062152 A1
(43) Pub. Date: Feb. 22, 2024

(54) SCAN-FREE ORDER FULFILLMENT

(71) Applicant: TAKEOFF TECHNOLOGIES, INC., Waltham, MA (US)

(72) Inventor: Curt Avallone, Scituate, MA (US)

(73) Assignee: TAKEOFF TECHNOLOGIES, INC., Waltham, MA (US)

(21) Appl. No.: 18/234,455

(22) Filed: Aug. 16, 2023

Related U.S. Application Data
(60) Provisional application No. 63/371,538, filed on Aug. 16, 2022.

(51) Int. Cl. G06Q 10/087; B65G 1/137

(52) U.S. Cl. CPC G06Q 10/087; B65G 1/1373

(57) ABSTRACT

Aspects of the disclosure include a method of fulfilling product orders, the method comprising receiving an order for a plurality of products including a first product and a second product, instructing a picker to bring at least one tote to the first product, controlling at least one light-emitting component corresponding to at least one of the first product or the at least one tote to emit light to the picker, determining that the picker has packed the first product in the at least one tote, and instructing the picker to bring the at least one tote to the second product.

### CROSS-REFERENCE TO RELATED APPLICATIONS

This application claims priority under 35 U.S.C. § 119(e) to U.S. Provisional Application Ser. No. 63/371,538, titled “SCAN-FREE ORDER FULFILLMENT,” filed on Aug. 16, 2022, which is hereby incorporated by reference in its entirety.

### BACKGROUND

### 1. Field of the Disclosure

At least one example in accordance with the present disclosure relates generally to order fulfillment.

### 2. Discussion of Related Art

Customers often place orders (for example, via the internet, in a physical store, and so forth) for one or more products from a product supplier, such as a retailer. The product supplier may fulfill the orders by picking the one or more products from a storage area, packing the one or more products into one or more containers, and shipping the one or more containers to the individual who placed the order. The one or more products may be picked by humans, robots, a combination thereof, and so forth.

### SUMMARY

According to at least one aspect of the present disclosure, a method of fulfilling product orders, the method comprising receiving an order for a plurality of products including a first product and a second product, instructing a picker to bring at least one tote to the first product, controlling at least one light-emitting component corresponding to at least one of the first product or the at least one tote to emit light to the picker, determining that the picker has packed the first product in the at least one tote, and instructing the picker to bring the at least one tote to the second product.

In some examples, the at least one tote includes a first tote and a second tote. In various examples, the first tote includes a first light-emitting component and the second tote includes a second light-emitting component. In at least one example, the method includes determining that the first product is to be packed in the first tote, and controlling the at least one light-emitting component corresponding to the at least one of the first product or the at least one tote to emit light to the picker includes controlling the first light-emitting component to emit light. In some examples, the first product is stored in a storage area having a third light-emitting component, and controlling the at least one light-emitting component corresponding to the at least one of the first product or the at least one tote to emit light to the picker further includes controlling the third light-emitting component to emit light.

In various examples, the method includes controlling the first light-emitting component and the third light-emitting component to emit light of the same color. In at least one example, the method includes determining that the second product is to be packed in the second tote, and controlling the second light-emitting component to emit light. In some examples, the second product is stored in a storage area having a fourth light-emitting component, and the method includes controlling both the second light-emitting component and the fourth light-emitting component to emit light. In various examples, the method includes controlling the second light-emitting component and the fourth light-emitting component to emit light of the same color. In at least one example, the method includes receiving, from at least one camera, visual information indicative of the first product, and determining, based on the visual information, that the picker has packed the first product in the at least one tote.

In some examples, determining that the picker has packed the first product in the at least one tote includes executing at least one computer-vision algorithm with respect to the visual information. According to at least one aspect of the disclosure, a non-transitory computer-readable medium storing thereon sequences of computer-executable instructions for fulfilling product orders is provided, the sequences of computer-executable instructions including instructions that instruct at least one processor to receiving an order for a plurality of products including a first product and a second product, instruct a picker to bring at least one tote to the first product, control at least one light-emitting component corresponding to at least one of the first product or the at least one tote to emit light to the picker, determine that the picker has packed the first product in the at least one tote, and instruct the picker to bring the at least one tote to the second product.

In some examples, the at least one tote includes a first tote having a first light emitting component and a second tote having a second light-emitting component, the instructions further instruct the at least one processor to determine that the first product is to be packed in the first tote, and controlling the at least one light-emitting component corresponding to the at least one of the first product or the at least one tote to emit light to the picker includes controlling the first light-emitting component to emit light. In various examples, the first product is stored in a storage area having a third light-emitting component, and controlling the at least one light-emitting component corresponding to the at least one of the first product or the at least one tote to emit light to the picker further includes controlling the third light-emitting component to emit light.

In at least one example, the instructions further instruct the at least one processor to control the first light-emitting component and the third light-emitting component to emit light of the same color. In some examples, the instructions further instruct the at least one processor to determine that the second product is to be packed in the second tote, and control the second light-emitting component to emit light. In various examples, the second product is stored in a storage area having a fourth light-emitting component, and the instructions further instruct the at least one processor to control both the second light-emitting component and the fourth light-emitting component to emit light.

In at least one example, the instructions further instruct the at least one processor to control the second light-emitting component and the fourth light-emitting component to emit light of the same color. In some examples, the instructions further instruct the at least one processor to receive, from at least one camera, visual information indicative of the first product, and determine, based on the visual information, that the picker has packed the first product in the at least one tote. In various examples, determining that the picker has packed the first product in the at least one tote includes executing at least one computer-vision algorithm with respect to the visual information.

According to at least one aspect of the disclosure, an order-fulfillment system is provided comprising one or more cameras, at least one user communication device corresponding to a picker, at least one tote, each tote having at least one tote light-emitting component, a plurality of products including a first product and a second product, each product corresponding to at least one product light-emitting component, and at least one order-management controller configured to instruct the picker to bring the at least one tote to the first product, control at least one of the at least one tote light-emitting component or the product light-emitting component to emit light to the picker, determine that the picker has packed the first product in the at least one tote, and instruct the picker to bring the at least one tote to the second product.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of an order-fulfillment facility according to an example;

FIG. 2 illustrates a process of fulfilling an order according to an example;

FIG. 3 illustrates a block diagram of an order-fulfillment system according to an example;

FIG. 4 illustrates a graphic representation of a product tag according to an example; and

FIG. 5 illustrates a process of fulfilling an order according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Customers may place orders for one or more products to be provided by a product supplier, such as retail stores, grocery stores, department stores, and so forth. For example, a customer may place an order for groceries from a grocery store. The customer may place the order physically in the grocery store or online. The grocery store may fulfill the order by picking the ordered groceries, packing the groceries into one or more containers (for example, boxes), and providing the packed boxes to the customer. For example, the grocery store may ship the packed boxes to the customer or may make the packed boxes available for in-store pickup.

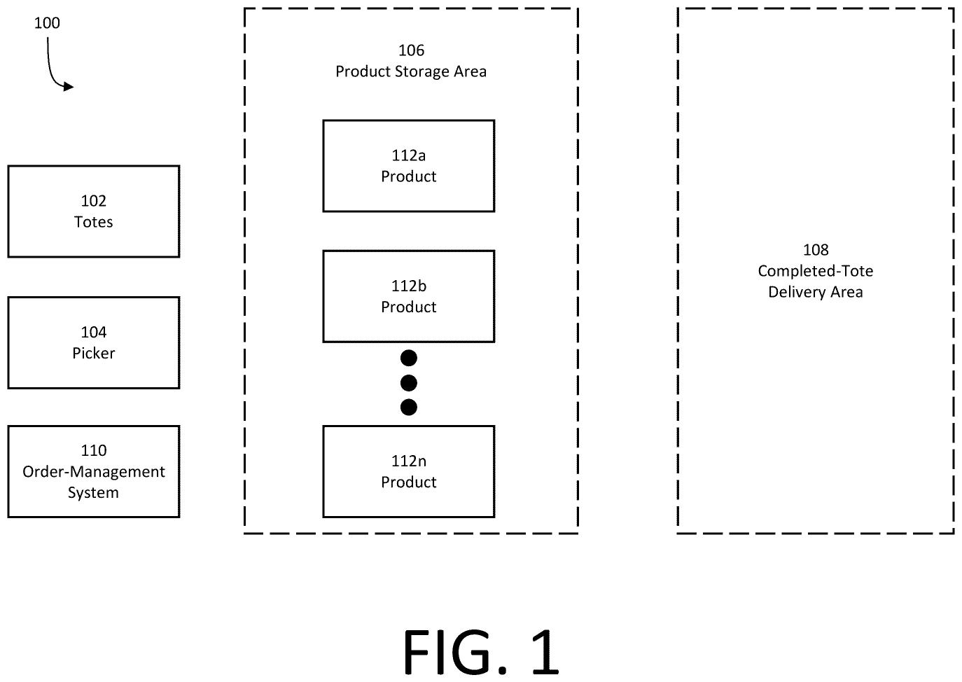

FIG. 1 illustrates a block diagram of an order-fulfillment facility 100 according to an example. The order-fulfillment facility 100 may be, for example, a warehouse, a grocery store, a retail facility, a convenience store, or another physical space having one or more products available to be ordered. In some examples, the order-fulfillment facility 100 may not be intended for customer access, but may be attached to a customer-facing area with products available for purchase. For example, the order-fulfillment facility 100 may be a “back room” attached to a customer-facing section of a store. In other examples, such as where the order-fulfillment facility 100 includes a customer-facing section of a grocery store, the order-fulfillment facility 100 may be physically accessible to customers, who may be able to walk around the order-fulfillment facility 100 and purchase products in person.

The order-fulfillment facility 100 includes one or more totes 102 (“totes 102”), one or more pickers 104 (“picker 104”), at least one product storage area 106 (“product storage area 106”), at least one completed-tote delivery area 108 (“delivery area 108”), and an order-management system 110. The product storage area 106 includes an arbitrary number of one or more products including a first product 112a, a second product 112b, and a third product 112n (collectively, “products 112”). However, the product storage area 106 may include more or fewer than three products, such as by including thousands of products.

A customer may place an order (for example, remotely via the internet, via an in-store kiosk, and so forth) for one or more of the products 112. The order may be communicated to the order-management system 110. The order-management system 110 may include one or more computing devices, such as a computer servers, controllers, processors, and so forth, to receive orders and manage the fulfillment of the orders. The order-management system 110 may assign the picker 104 to pick the ordered products 112 from the storage area 106 and pack the picked products 112 into the totes 102. The picker 104 may then bring the packed totes 102 to the delivery area 108. At the delivery area 108, a packager may remove the packed products from the totes 102 and package the products in a container suitable for delivery to a customer, such as a cardboard box. Examples provided herein may use the term “cardboard box” to refer to containers that are provided to customers with the customers' products inside. However, cardboard boxes are only one example of such containers. References to cardboard boxes are provided for ease of explanation and are not intended to be limiting on any particular material for containers that are delivered to customers.

The totes 102 may include containers to store one or more products (for example, the products 112). Unlike cardboard boxes or other containers intended for delivery to a customer, the totes 102 may be designed for transporting the products 112 around the order-fulfillment facility 100 and intended to remain inside the order-fulfillment facility 100. The totes 102 may have flaps or “doors” that can be opened and closed to unseal and seal the totes 102. The flaps or “doors” may be pulled apart to unseal and open the totes 102. Products may then be placed inside the totes 102. The flaps or “doors” may overlap and interlock with one another when closed to seal the totes 102. In some examples, some of the totes 102 may be insulated and/or climate-controlled (for example, by having a controllable temperature and/or humidity). For example, some of the totes 102 may be insulated and/or climate-controlled where the totes 102 are intended to store goods that are to be refrigerated and/or frozen. In various examples, the totes 102 may include energy-storage devices, such as batteries, to store energy to be delivered to climate-control components or other electronic components.

The picker 104 may include a human picker, a robotic picker, or a combination thereof. For example, a human picker may be equipped with a headset, a smartphone, or some other user communication device to receive order instructions from the order-management system 110. A robotic picker, which may include an autonomous robot, may be equipped with a communication interface (for example, one or more antennas) to receive order instructions from the order-management system 110. The order instructions may indicate a type and/or number of the totes 102 to pick up for an order, which of the products 112 to pack into which of the totes 102, and where the packed totes 102 are to be delivered by the picker 104 in the delivery area 108.

The product storage area 106 may include an area in which the products 112 are stored. In some examples, the product storage area 106 may include an array of shelving units or other product storage on which the products 112 are placed. In one example, such as where the order-fulfillment facility 100 is a warehouse or other non-customer-facing fulfillment center, the product storage area 106 may include shelving units arranged to optimize order fulfillment operations. In other examples, such as where the order-fulfillment facility 100 is a retail store or other customer-facing and customer-accessible area, the product storage area 106 may include shelving units, tables, product displays, or other storage arranged to enhance a customer's shopping experience. For example, the product storage area 106 may include a produce section as is featured in some grocery stores. In some examples, the product storage area 106 may include two or more different climate zones. For example, one zone of the product storage area 106 may be maintained at a climate suitable for frozen goods, another area of the product storage area 106 may be maintained at a climate suitable for refrigerated goods, and another area of the product storage area 106 may be maintained at a climate that is simply comfortable for human associates or customers, but which is not selected based on the needs of products stored therein.

The delivery area 108 may include an area in which packed totes 102 are prepared for delivery to a customer. In some examples, the totes 102 may be intended to remain inside the order-fulfillment facility 100. Preparing the totes 102 for delivery to a customer may include removing the products from the totes 102 and repacking the products into boxes (for example, cardboard boxes) that can be delivered to a customer outside of the order-fulfillment facility 100. Delivery to the customer may include making the packed boxes available for in-store pickup or delivering the packed boxes to a customer offsite. If the boxes are to be made available for in-store pickup, the packed boxes may be moved from the delivery area 108 to a section of the order-fulfillment facility 100 (or a customer-facing area that is near the order-fulfillment facility 100) that is designated for customer order pickup. If the boxes are to be shipped offsite, the packed boxes may be moved from the delivery area 108 onto delivery vehicles, such as delivery trucks. For example, the delivery area 108 may include one or more conveyors (for example, conveyor belts) to convey packed boxes to delivery trucks.

The products 112 may include any articles that are stored in the order-fulfillment facility 100 to be ordered and/or purchased by customers. For example, the products may include clothing, groceries, electronics, housewares, or any other articles available for purchase from stores. The products 112 may be stored in appropriate areas of the product storage area 106, which may include storing frozen products in a climate-controlled area of the product storage area 106, and so forth.

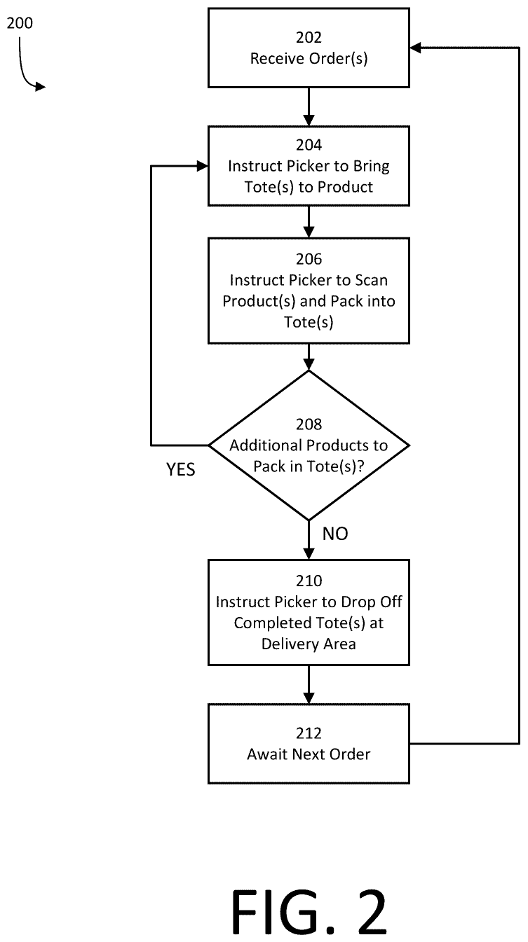

FIG. 2 illustrates a process 200 of fulfilling an order according to an example. In one example, the process 200 may be executed by the order-management system 110. The order-management system 110 may comprise hardware including one or more computer-readable media storing instructions thereon that, when executed by one or more processors, executes at least the process 200 and/or portions thereof.

At act 202, the order-management system 110 receives an order for one or more products. The order may be received from a customer. The customer may place the order via an electronic device, such as an in-store kiosk or a customer computer remote from the order fulfillment facility 100. The order may be communicated to the order-management system 110 via a computer network, such as a local network or the internet. In some examples, act 202 includes receiving multiple orders from the same customer or an order from each of several customers.

At act 204, the order-management system 110 selects the picker 104 to fulfill the one or more orders and instructs the picker 104 to bring at least one of the totes 102 to one of the products 112. The picker 104 may be selected because the picker 104 is ready, or will soon be ready, to fulfill an order. Act 204 may include the order-management system 110 determining a type and/or number of the totes 102 that the picker 104 will need based on the type and/or number of the products 112 in the one or more orders. For example, the order-management system 110 may instruct the picker 104 to acquire a refrigerated tote if the orders include an order for a refrigerated product.

Act 204 may include the order-management system 110 determining a desired sequence for the picker 104 to pick the products and instructing the picker 104 to proceed to the first one of the products 112 in the desired sequence. In one example, the desired sequence may be selected to minimize a distance that the picker 104 travels. Minimizing a travel distance of the picker 104 may increase a speed at which orders are fulfilled. Instructing the picker 104 to proceed to the first one of the products 112 may include sending wireless instructions to the picker 104 where the picker 104 is a robotic picker, and/or may include sending human-comprehensible instructions to the picker 104 where the picker 104 is a human being. For example, where the picker 104 is a human being, the picker 104 may carry a smartphone, headset, or other user communication device. The user communication device 306 may present the instructions to the picker 104 as a spoken audio message, a written text message, a combination thereof, and so forth. In other examples, the order-management system 110 may transmit a list of products corresponding to the order to the picker 104 (for example, as a text message displayed on a smartphone), and the picker 104 may determine a sequence in which to pick the products.

At act 206, the order-management system 110 instructs the picker 104 to scan an ordered product, pack the scanned product into an appropriate one of the totes 102, and scan the tote into which the scanned product has been packed. Scanning may be performed using a handheld scanner or a smartphone, for example. The scanning information may be transmitted to the order-management system 110. Scanning the products 112 may include scanning, for example, a bar code or QR code affixed to the products 112 or on a shelving unit on which the products 112 are stored. Scanning the totes 102 may include scanning, for example, a bar code or QR code affixed to the totes 102. The order-management system 110 may manage the picking and packing of products using the scanning information.

For example, because the scanning information indicates which of the products 112 was picked, the order-management system 110 may ensure that the picked product is the correct product (that is, a product ordered by the customer). Because the scanning information indicates which of the totes 102 the product was packed into, the order-management system 110 may ensure that the tote into which the product has been packed is the correct tote (that is, the tote assigned to the customer whose order is being fulfilled). The scanning information may also enable the order-management system 110 to accurately track inventory levels. For example, each time a product is scanned and packed into a tote, the order-management system 110 may update a record of the available inventory of that product to reflect that less inventory is available. In some examples, the order-management system 110 may instruct the picker 104 to fulfill multiple orders for multiple customers on a single trip into the product storage area 106. The picker 104 may thus have multiple totes 102, some of which may correspond to one order and some of which may correspond to other orders. Accordingly, the order-management system 110 may instruct the picker 104 to pack the picked products into particular ones of the totes 102 to ensure that a product in one order for one customer is packed into one tote, and a product in another order for another customer is packed into another, different tote. The order-management system 110 may ensure that the correct product has been packed into the correct tote using the scanning information.

At act 208, the order-management system 110 determines whether there are additional products to pack into the totes 102. For example, the order-management system 110 may determine if any products listed in the order or orders received at act 202 have yet to be picked, scanned, and packed into the totes 102. If additional products remain to be packed in an order being fulfilled (208 YES), then the process 200 returns to act 204. Upon returning to act 204, the order-management system 110 instructs the picker 104 to proceed to the next product in the order or orders. In other example, such as where the order-management system 110 simply sends a list of products to the picker 104 and allows the picker 104 to determine a sequence in which to pick the products, the order-management system 110 may simply acknowledge that a product has been picked but not explicitly instruct the picker 104 to proceed to the next product. Acts 204-208 are repeated until the order-management system 110 determines at act 208 that all products in the order or orders received at act 202 have been picked, scanned, and packed into the totes 102 (208 NO), at which point the order-management system 110 determines that the totes 102 are completed. The process 200 then continues to act 210.

At act 210, the order-management system 110 instructs the picker 104 to bring the completed totes 102 to the delivery area 108. The delivery area 108 may be an area in which products are removed from the totes 102, packaged in cardboard boxes, and shipped or otherwise made available to customers. In some examples, the delivery area 108 may include multiple tote drop-off areas, such as multiple dispatch lanes. Each of the drop-off areas may be staffed by a packager that packages the products in cardboard boxes. The packager may include a human packager and/or a robotic packager. The drop-off area may include a conveyor belt to convey the totes 102 to the packager and convey packaged cardboard boxes away from the packager. The packager may extract the products from the totes 102 and package the products into one or more different containers, such as cardboard boxes. The cardboard boxes may then be provided (for example, via the conveyor belt) to a delivery vehicle for delivery to a customer, or may be placed in a customer-accessible pick-up area. Act 210 may thus include the order-management system 110 instructing the picker 104 to bring the completed totes 102 to an appropriate area in the delivery area 108, such as by instructing the picker 104 to bring the completed totes 102 to a designated dispatch lane.

At act 212, the order-management system 110 may await a next order. The process 200 may then return to act 202 when an order is received. In some examples, the order-management system 110 may execute multiple instances of the process 200 in parallel. For example, while the order-management system 110 is selecting one of the pickers 104 to fulfill one order (act 204), the order-management system 110 may be simultaneously instructing another picker to bring completed totes 102 with a second order to the delivery area 108 (act 210).

Accordingly, the process 200 may be executed by the order-management system 110 to fulfill orders received from customers. The order-management system 110 may receive feedback at least in part as scanning information received from the picker 104 (for example, from a scanning device, such as a dedicated scanner or smartphone, operated by the picker 104). The scanning information may indicate when a product has been removed from the product storage area 106, since the picker 104 scans a product after removing the product from the product storage area 106. The order-management system 110 may use this scanning information to decrement an inventory count for that product. The scanning information may also indicate which tote a product has been placed into, since the picker 104 scans a tote into which a product is placed. The order-management system 110 may use this scanning information to track inventory and ensure that products are placed in the correct totes.

Scanning information used in scanning-based processes, such as the process 200, provides the order-management system 110 with valuable feedback information. However, the necessity for the picker 104 to scan a product and a tote for each picked product may slow down a speed at which the picker 104 can fulfill orders. In addition, human error may lead to scanning errors, such as where the picker 104 picks one product but scans a different product.

In light of the foregoing, examples of the disclosure product an order-fulfillment system that increases a speed at which orders may be fulfilled without jeopardizing inventory management, product tracking, and tote-content verification. In one example, totes and product labels may be equipped with multi-color light-emitting components (for example, light-emitting diodes). Pickers may be guided (for example, via a headset) to a product that is to be picked and placed into a target tote. The light-emitting components on both the target tote and the product label may blink the same color of light to guide the picker to pick and pack the product. For example, a label on the target product and a label on the target tote may both blink a yellow light, indicating that the picker is to place the target product in the target tote.

In various examples, the order-fulfillment system may further include an array of cameras that capture visual information of the products and totes. The visual information may include video or images of products, totes, and/or labels associated with the products and/or totes. The cameras (or an order-management system receiving information from the cameras) may employ one or more computer-vision algorithms to determine that a product has been picked, and to determine which tote a picked product is placed into. For example, the cameras may capture video or images or computer-readable bar codes or QR codes on the labels, and the computer-vision algorithms may be executed to read the bar codes or QR codes. Accordingly, examples of the disclosure enable a picker to quickly, easily, and accurately pack products into target totes (for example, aided by the light-emitting components) without requiring time-consuming scanning (for example, aided by the array of cameras and computer-vision algorithm[s]), and without jeopardizing inventory management and tote-content verification.

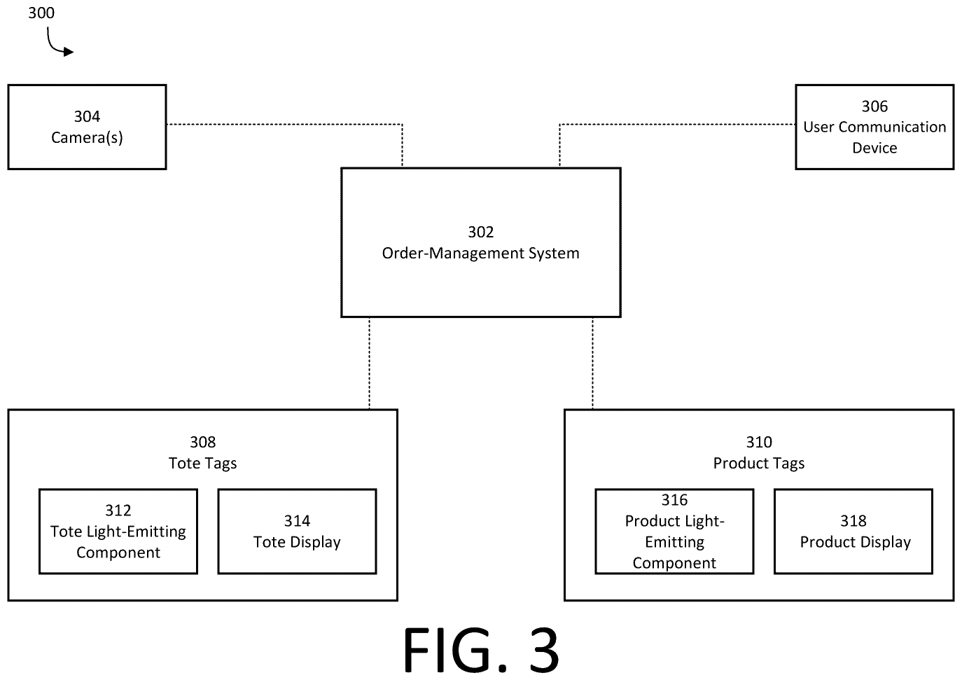

FIG. 3 illustrates a block diagram of an order-fulfillment system 300 according to an example. The order-fulfillment system 300 may be implemented in an order-fulfillment facility such as the order-fulfillment facility 100. However, the order-fulfillment system 300 may include components not illustrated in the order-fulfillment system 100 and the order-fulfillment system 300 may be implemented in an order-fulfillment facility having fewer than all of the components illustrated in the order-fulfillment facility 100. For example, the order-fulfillment system 300 may be implemented in an order-fulfillment facility that is substantially similar to the order-fulfillment facility 100, but which does not include the order-management system 110.

The order-fulfillment system 300 includes an order-management system 302, one or more cameras 304 (“cameras 304”), at least one user communication device 306 (“user communication device 306”), one or more tote tags 308 (“tote tags 308”), and one or more product tags 310 (“product tags 310”). Each of the tote tags 308, which may be affixed to respective totes (for example, the totes 102), includes one or more respective light-emitting components 312 (“tote light-emitting component 312”) and a respective tote display 314. Each of the product tags 310, which may be affixed to a section of a shelving unit or other storage area where a respective product is stored and/or directly to the products 112, includes one or more respective light-emitting components 316 (“product light-emitting component 316”) and a respective product display 318. In some examples, the tote tags 308 may include additional components, such as temperature sensors configured to sense a temperature inside and/or outside the respective tote.

A customer may place an order (for example, remotely via the internet, via an in-store kiosk in a customer area physically connected to or near the order-fulfillment facility 100, and so forth) for one or more of the products 112, and the order may be communicated to the order management system 300. The order-management system 302 may include one or more computing devices, such as a computer servers, controllers, processors, and so forth, to receive orders and manage the fulfillment of the orders.

The order-management system 302 may be similar to the order-management system 110. For example, the order-management system 302 may assign pickers to fulfill orders and manage order fulfillment based on feedback information. However, whereas the order-management system 110 may receive feedback information as scanning information, the order-management system 302 may receive feedback information as visual information captured by the cameras 304. The order-management system 302 and/or the cameras 304 may implement one or more computer-vision algorithms to analyze the visual information and, based on the analysis, manage order fulfillment. Furthermore, the order-management system 302 may guide the picker 104 in fulfilling an order by controlling the light-emitting components 312, 316 and/or the displays 314, 318 to visually draw the attention of the picker 104. The order-management system 302 may also guide order fulfillment by communicating instruction information to the user communication device 306. The user communication device 306 may output the instructions to the picker 104 as text, audio, a combination thereof, and so forth. In various examples, the order-management system 302 may include or be coupled to a wired and/or wireless communication interface, such as one or more antennas or wired communication ports, to communicate with the cameras 304, user communication device 306, tote tags 308, and/or product tags 310.

The cameras 304 include one or more video cameras. The cameras 304 may be arranged such that a collective field-of-view of the cameras 304 covers a substantial portion of the order-fulfillment facility 100, including the products 112. For example, the cameras 304 may be affixed to a ceiling of the order-fulfillment facility 100 and may point downwards towards the products 112. The cameras 304 may also be positioned such that the totes 102 are visible while the picker 104 packs the products 112 into the totes 102, thereby enabling the cameras 304 (or the order management system 300 receiving information from the cameras 304) to verify that an appropriate product has been packed into an appropriate tote. One of more of the cameras 304 may be placed at other locations in addition to or alternative to a ceiling of the order-fulfillment facility 100, such as on walls, on top of shelving units, within shelving units, and so forth.

The user communication device 306 includes one or more devices to communicate information to the picker 104. For example, the user communication device 306 may be a headset worn by the picker 104. The headset may provide audio information to the picker 104, such as an audio message indicating the next product that the picker 104 should pick and pack into the totes 102. The user communication device 306, which may include multiple different devices, may alternatively or additionally include a device with a visual display. For example, the user communication device 306 may include a smartphone or other personal digital to visually display a list of products in an order that the picker 104 is to fulfill. In various examples, the user communication device 306 includes a wireless communication interface, such as one or more antennas, configured to be communicatively coupled to the order-management system 302 via a corresponding communication interface.

The tote tags 308 include the tote light-emitting component 312 and the tote display 314. Each of the tote tags 308 is configured to be coupled to coupled to a respective one of the totes 102, and may be configured to be communicatively coupled to the order-management system 302. The tote light-emitting component 312 may be configured to emit light based on control signals received from the order-management system 302. For example, the tote light-emitting component 312 may be controlled to output a steady light of a first color, a blinking light of a second color, and so forth. The tote display 314 may be configured to output tote information indicative of the tote to which the respective tote tag 308 is affixed. For example, the tote information may include an order number of an order for products that are to be placed into the tote, a route number for the order, a spoke number identifying a destination or origin facility for the order, a tote number identifying the tote, an indication of how many totes are being used to fulfill an order and which ordinal number the respective tote is in that total number (for example, “Tote ½” to indicate that the tote is the first tote of two totes to be used in an order), and so forth.

The product tags 310 include the product light-emitting component 316 and the product display 318. Each of the product tags 310 is configured to be affixed on or near a respective one of the products 112 to which the respective one of the product tags 310 corresponds. For example, if the first product 112a is a roll of bath tissue stored on a shelving unit, then a corresponding one of the product tags 310 may be affixed to the shelving unit where the rolls of bath tissue are stored. Each of the product tags 310 may be configured to be communicatively coupled to the order-management system 302.

The product light-emitting component 316 may be configured to emit light based on control signals received from the order-management system 302. For example, the product light-emitting component 316 may be controlled to output a steady light of a first color, a blinking light of a second color, and so forth. The product display 318 may be configured to output information indicative of a product to which the respective product tag 310 corresponds. In one example, the product display 318 is an electronic display configured to output human-readable information (for example, words) and/or machine-readable information (for example, bar codes and/or QR codes). The product display 318 may be updated (for example, by the order-management system 302) to display different information over time, such as different price information as a price changes. In some examples, the product display 318 may be or include a physical, non-electronic display, such as a sticker placed on a shelving unit.

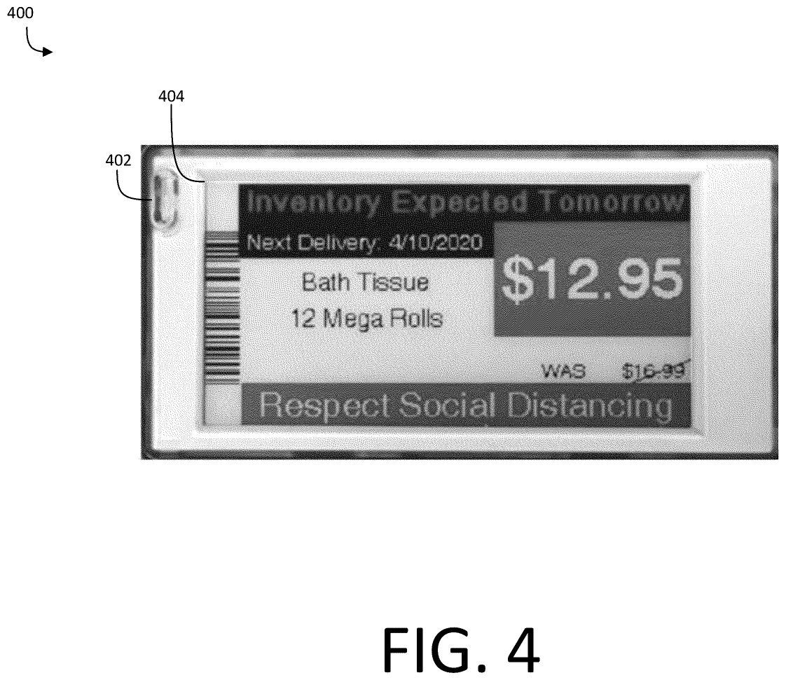

FIG. 4 illustrates a graphic representation of a product tag 400 according to an example. The product tag 400 may illustrate an example of the product tag 310. The product tag 400 includes a light-emitting component 402, which may be an example of the product light-emitting component 316, and a display 404, which may be an example of the product display 318. The light-emitting component 402 may be a light-emitting diode “bean” configured to output light of various colors in a steady or blinking pattern. The light-emitting component 402 may output light of a particular color to signal to the picker 104 that the picker 104 is to pick the product corresponding to the illuminated light-emitting component 402. The display 404 may output information indicative of which of the products 112 the display 404 corresponds to. For example, the display 404 may display text indicating a name of the product, a price of the product, information indicative of current and/or future inventory of the product, and so forth. In some examples, the display 404 may be configured to output additional or different information to aid a picker. For example, if the picker 104 is to pick a product corresponding to the display 404, the display 404 may be controlled (for example, by the order-management system 302) to output a name of the customer to whom an order corresponds such that the picker 104 knows to pick that product.

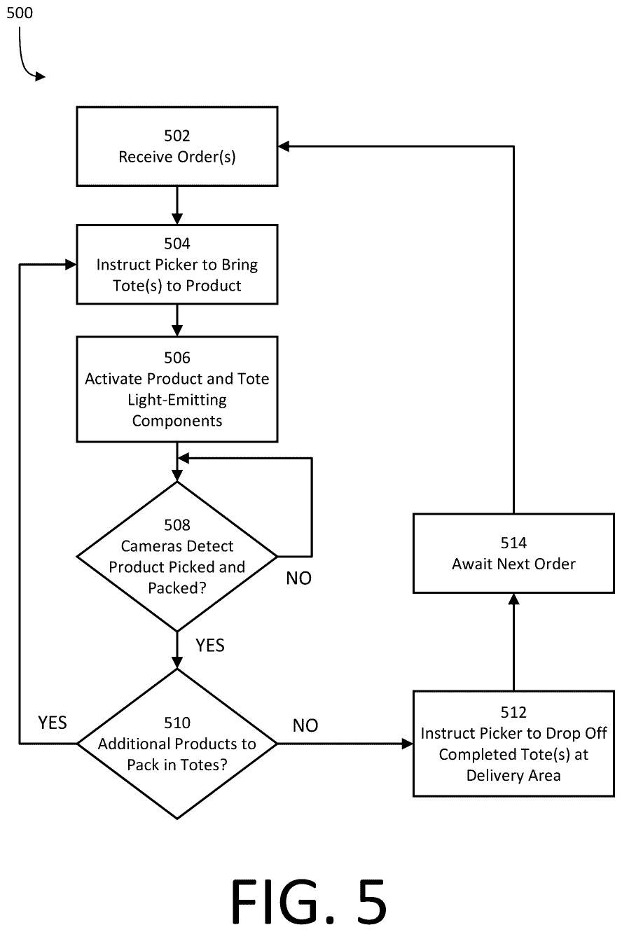

FIG. 5 illustrates a process 500 of fulfilling an order according to an example. In various examples, the process 500 may be executed at least in part by the order-management system 302. The order-management system 302 may include one or more computing devices, such as at least one controller (or “order-management controller”). The at least one controller may include or be coupled to hardware including one or more computer-readable media storing instructions thereon that, when executed by one or more processors, execute at least the process 500 and/or portions thereof. The order-management system 302 and/or the at least one controller may include the one or more processors.

As discussed above, the totes 102 may include multiple totes and the picker 104 may include multiple pickers. Examples of the process 500 are provided with respect to one or more orders that are fulfilled by a single picker using one or more totes. For purposes of simplicity and explanation, examples of the process 500 provided below may refer to this single picker as the “picker 104,” even though the picker 104 may include multiple additional pickers not fulfilling the one or more orders discussed with respect to the process 500. Similarly, for purposes of simplicity and explanation, examples of the process 500 provided below may refer to the one or more totes used by the single picker as the “totes 102,” even though the totes 102 may include additional totes not being used by the single picker. Accordingly, references to the picker 104 and the totes 102 may refer to fewer than all of the pickers and totes, respectively, in the order-fulfillment facility 100.

At act 502, the order-management system 302 receives an order for one or more products. The order may be received from a customer. The customer may place the order via an electronic device, such as an in-store kiosk or a customer's personal computer remote from the order-fulfillment facility 100. The order may be communicated to the order-management system 302 via a computer network, such as the internet. In some examples, act 502 includes receiving multiple orders from the same customer or from multiple customers. The order-management system 302 may accumulate multiple orders over time until enough orders have been received to assign the orders to a picker. For example, the order-management system 302 may accumulate orders until the number of the totes 102 that would be used to satisfy the orders meets or exceeds a threshold number of totes. The threshold number of totes may represent a number of totes that the picker 104 can efficiently transport around the order-fulfillment facility 100.

At act 504, the order-management system 302 selects the picker 104 to fulfill the one or more orders and instructs the picker 104 to bring at least one of the totes 102 to one of the products 112. The order-management system 302 may instruct the picker 104 by communicating with the user communication device 306. The order-management system 302 may control the user communication device 306 to output audio and/or text information to the picker 104. For example, if the user communication device 306 includes a headset and/or a smartphone, the order-management system 302 may control the headset to output an audio message and/or may control the smartphone to display a text message.

The picker 104 may be selected because the picker 104 is ready, or will soon be ready, to fulfill an order. For example, where multiple pickers are working in the order-fulfillment facility 100, the picker 104 may be selected because the picker 104 is ready, or will be ready soonest out of all of the pickers, to fulfill an order. Act 504 may include the order-management system 302 determining a type and/or number of the totes 102 that the picker 104 will need. The type and/or number of the totes 102 may be determined based on the type and/or number of the products 112 in the one or more orders. For example, if the one or more orders include an order for a refrigerated product, the order-management system 302 may instruct the picker 104 to acquire a refrigerated tote. In various examples, act 504 may include assigning orders for multiple customers to the picker 104 for the picker 104 to fulfill simultaneously. For example, act 504 may include assigning an average of three to eight customers' orders to the picker 104.

Act 504 may include the order-management system 302 determining a desired sequence for the picker 104 to pick the products. For example, the desired sequence may be a picking sequence that minimizes the distance that the picker 104 travels. Act 504 may further include the order-management system 302 instructing the picker 104 to proceed to the first one of the products 112 in the desired sequence. In other examples, the order-management system 302 may transmit a list of products corresponding to the order to the picker 104 (for example, as a text message displayed on a smartphone), and the picker 104 may determine a sequence in which to pick the products.

At act 506, the order-management system 302 activates at least one of the tote light-emitting components 312 and at least one of the product light-emitting components 316. For example, the order-management system 302 may activate the product light-emitting component 316 corresponding to a target product that the picker 104 is to pick. The order-management system 302 may activate the tote light-emitting component 312 corresponding to a target tote that the picker 104 is to pack the product into. Activating the light-emitting components 312, 316 may include communicating control signals to the light-emitting components 312, 316 to control the light-emitting components 312, 316 to emit a specified color of light. For example, if the picker 104 has been guided at act 504 to an area including bath tissue, the product light-emitting component 316 corresponding to the bath tissue may be controlled to output a blinking yellow light. The attention of the picker 104 may be drawn to the blinking yellow light such that the picker 104 knows to pick the bath tissue. The tote light-emitting component 312 corresponding to the tote 102 intended to receive the bath tissue may also be controlled to output a blinking yellow light. The attention of the picker 104 may be drawn to the blinking yellow light such that the picker 104 knows to pack the bath tissue in the tote corresponding to the blinking yellow tote light-emitting component 312.

If the picker 104 is picking items for multiple orders at once, the colors of the emitted lights may aid the picker 104 in ensuring that the appropriate products are placed in the appropriate totes by matching colors. Each color may correspond to a different customer's order. That is, the picker 104 may know that products corresponding to a blinking light of one color are to be placed in totes corresponding to a blinking light of that color, whereas products corresponding to a blinking light of another color are to be placed in totes corresponding to a blinking light of that other color. Accordingly, the picker 104 may efficiently and accurately pick and pack products by simply matching colors of products and totes. The cameras 304 may be pointed at the products 112 that the picker 104 picks and at the totes 102 into which the picker 104 packs the picked products 112.

In some examples of act 506, the order-management system 302 may additionally or alternatively control the product display 318 to display information to aid the picker 104 in fulfilling an order. For example, the order-management system 302 may control the product display 318 to display messages such as “Pick two of this product for the yellow-blinking tote,” “Pick one of this product for the yellow-blinking tote, and two of this product for the blue-blinking tote,” a name of the person whose order the product corresponds to, and so forth.

At act 508, the order-management system 302 determines, based on information received from the cameras 304, whether the product that the picker 104 was instructed to pick at act 504 has been successfully picked and placed into a correct tote. The visual information may include images and/or video of the totes 102, products 112, the tote tags 308, and/or the product tags 310. For example, the visual information may include bar codes or QR codes on the tote tags 308, product tags 310, and/or products 112.

In some examples, the cameras 304 provide captured visual information to the order-management system 302. The computer-management system 302 may use the visual information to determine which products have been placed into which totes. The order-management system 302 may execute one or more computer-vision algorithms with respect to the received visual information to determine whether the appropriate product has been picked and placed into an appropriate tote. For example, the computer-vision algorithms may analyze bar codes or QR codes to discern information encoded therein. In other example, the cameras 304 may directly execute one or more computer-vision algorithms using visual information captured by the cameras 304 themselves and send results of the computer-vision algorithms to the order-management system 302. If the order-management system 302 determines that the picker 104 has not yet picked and packed the product (508 NO), the process 500 may continuously re-execute act 508.

If the order-management system 302 determines that the correct product has been picked but placed into the incorrect tote, the order-management system 302 may provide feedback information to the user communication device 306 to inform the picker 104 (for example, via an audio message) that an error has been made. The picker 104 may then move the product to the appropriate tote. The cameras 304 may capture visual information of the picker 104 doing so, and send the visual information to the order-management system 302. The order-management system 302 may consequently determine that the picker 104 has picked the appropriate product and placed the product into the appropriate tote. Similarly, if the computer-management system 302 determines that an incorrect product has been picked, the order-management system 302 may provide feedback information to the user communication device 306 to inform the picker 104 (for example, via an audio message) that an error has been made. The picker 104 may remove the incorrect product and place the product back in its designated section of the product storage area 106. The picker 104 may then pick the correct product to place into the appropriate tote. The cameras 304 may capture visual information of the picker 104 exchanging the products and send the visual information to the order-management system 302.

Otherwise, if the order-management system 302 determines that the picker 104 has picked and packed the correct product in the correct tote (508 YES), then the process 500 continues to act 510. At act 510, the order-management system 302 determines whether there are additional products to pack into the totes 102. The order-management system 302 may determine whether any products remain to be packed from any of the one or more orders presently being fulfilled by the picker 104. For example, although one or more orders presently being fulfilled by the picker 104 may be complete and fully packed into the totes 102, one or more additional orders may still remain to be completed. If any of the orders have not been completed, and additional products thus remain to pack into the totes 102 (510 YES), then the process 500 returns to act 504. The order-management system 302 then instructs the picker 104 to proceed to the next product and acts 504-510 are repeated. Otherwise, if all of the orders have been completed and all ordered products have been packed into appropriate totes (510 NO), then the process 500 continues to act 512.

At act 512, the order-management system 302 instructs the picker 104 to drop off the completed totes 102 at the delivery area 108. In some examples, the delivery area 108 may include multiple tote drop-off areas. Each of the drop-off areas may be managed by at least one packager, which may include a human packager and/or a robotic packager. The packager may remove the products from the totes 102 and package the products into one or more different containers, such as cardboard boxes. The cardboard boxes may then be placed on a delivery vehicle for delivery, or may be placed in a customer-accessible pick-up area. Act 512 may thus include the order-management system 302 instructing the picker 104 to bring the completed totes 102 to an appropriate dispatch lane in the delivery area 108. For example, the order-management system 302 may provide information to the user communication device 306 such that the user communication device 306 instructs the picker 104 (for example, via an audio message) to proceed to a certain dispatch lane. If the picker 104 is fulfilling multiple orders for multiple customers, act 512 may include instructing the picker 104 to drop off the completed totes 102 at multiple dispatch lanes.

At act 514, the order-management system 302 may await a next order. The process 500 may then return to act 502 when an order is received. In some examples, the order-management system 302 may execute multiple instances of the process 500 in parallel. For example, while the order-management system 302 is selecting one of the pickers 104 to fulfill one order (act 504), the order-management system 302 may be simultaneously instructing another picker to bring completed totes 102 with a second order to the delivery area 108 (act 512).

In light of the foregoing, the order-fulfillment system 300 may be implemented in an order-fulfillment facility (for example, the order-fulfillment facility 100) to improve a speed and efficiency of order fulfillment without adversely impacting order content. Examples of the disclosure aid a picker in picking a correct product and packing the product into a correct tote at least in part by using color-coded lights. For example, light-emitting components on a target tote and on a shelving unit on which a product is stored may blink with the same color to guide the picker. Examples of the disclosure may also improve efficiency of picking and packing by confirming that a correct item has been picked and placed into a correct tote using an array of cameras and computer-vision algorithms, rather than tracking inventory movement using scanning information acquired by, for example, a handheld scanner used by the picker 104.

Examples of the disclosure may be implemented in any of various facilities. For example, examples of the disclosure may be implemented in a customer-facing section of a retail or grocery store in which both order pickers and shoppers move about. In another example, examples of the disclosure may be implemented in a warehouse-style order-fulfillment center to which shoppers may not have access.

Pickers may include human pickers and/or robot pickers. In some examples, an order may be fulfilled using a combination of human pickers and robot pickers. For example, some products in an order may be picked by a human picker, and the remaining products in the order may be picked by a robot picker. The products may eventually be packaged together or separately and delivered to a customer.

In one example, an order-fulfillment facility may include different sections for different products. Products in one section may be picked by human pickers, and products in another section may be picked by robot pickers. The different sections may be determined based on how frequently the products stored in those sections are ordered. For example, an order-fulfillment facility may store 5,000 different types of products, yet a small number of those products (for example, 500 products) may account for 85% of orders. In some examples, a first section of an order-fulfillment facility may be used to store the most frequently ordered products (for example, the 500 products noted above) and a second section of the order-fulfillment facility may be used to store the remaining products (for example, the remaining 4,500 products noted above).

Products may be picked differently in the first and second sections. For example, products in the second section (that is, the least frequently ordered products) may be picked by human pickers. The human pickers may pick products in the second section pursuant to examples discussed herein. For example, the order-management system 302 may guide human pickers in fulfilling orders pursuant to the process 500. Accordingly, human pickers may be responsible for picking the least frequently ordered products.

Products in the first section (that is, the most frequently ordered products) may be picked by robot pickers. Products in the first section may be stored in a storage area that is adapted to robot pickers. For example, products may be stored in an array of shelving units having discrete storage compartments for each type of product and/or non-discrete, continuous shelving units for storing products. In some examples, the robot pickers may travel along an aisle between two adjacent shelving units. In various examples, the shelving units themselves may be adapted for the robot picker to traverse. For example, products may be stored in a two- or three-dimensional array of storage areas including, or coupled to, robot-traversable rails. In one example, the first section of the example order-fulfillment facility includes a single aisle flanked by two shelving units (or two groups of shelving units) on which the most frequently picked products are stored.

The robot picker may be controlled by an order-management system (for example, the order-management system 302) to travel down the aisle, picking ordered products as the robot picker progresses down the aisle. The robot picker may be able to pick products more quickly than a human picker. However, equipping a storage area to be accessible to a robot picker may require higher costs than, for example, training a human picker. Accordingly, the higher upfront costs of a robot picker may be outweighed by the benefits of the robot picker's speed only if the products stored in the robot-accessible storage area are frequently accessed.

By implementing an order-fulfillment facility in which only the most frequently picked products are stored in robot-accessible storage areas, infrastructure and equipment costs may be lower than if all products were picked by robot pickers because only a small number (albeit frequently ordered) of products are stored in the first section of the order-fulfillment facility. A large number of products may be stored in the second section of the order-fulfillment facility, which does not need to be equipped to be accessible to robot pickers. Accordingly, substantial improvements in order-fulfillment speed and efficiency may be achieved without requiring substantial equipment and infrastructure costs (for example, robot pickers and robot-accessible shelving units) by only picking the most frequently ordered products with a robot picker.

In various examples, when an order is received in such a facility, the process 500 may be executed with respect to the least frequently ordered products, if any, in the order. A human picker may pick the least frequently ordered products in the order, guided by the order-management system 302. A robot picker may also be dispatched (for example, by the order-management system 302 simultaneously with executing the process 500) to pick the most frequently ordered products, if any, in the order. Both the human picker and the robot picker may pack the picked products in different totes, but deliver the totes to the same delivery area. For example, the human and robot pickers may deliver their respective totes to the same dispatch lane in the delivery area 108. A packager may receive the tote(s) provided by the human picker and the tote(s) provided by the robot picker and package the products together or separately.

As discussed above, one or more cameras may be arranged in various areas of a facility to capture all relevant targets in a cumulative field-of-view of the cameras. Relevant targets may include products, product tags, totes, tote tags, and so forth. As discussed above, cameras may be used to verify that a correct product has been picked and packed into a correct tote by detecting when a picker removes the product from a storage area (for example, a shelf) and places the product into a tote. In some examples, at least one computer-vision algorithm is employed to detect which product is placed into which tote. The at least one computer-vision algorithm may be executed to track movement of products to determine when products are removed from storage and when products are placed into totes.

In one example, cameras may capture, and the at least one computer-vision algorithm may take as input, images or video of a product label and/or tote label. For example, the cameras 304 may capture images or video of the tote tags 308 and/or product tags 310, including, for example, information displayed on the tote display 314 and/or product display 318. Such information may include bar codes or QR codes, for example, which may encode product and/or tote information. Accordingly, in addition to tracking movement of products, the at least one computer-vision algorithm may analyze bar codes and/or QR codes to determine which products are placed into which totes. The order-management system 302 may execute the at least one computer-vision algorithm.

In some examples, the cameras 304 may detect information indicative of fungible or non-fungible products. Fungible products may include substantially interchangeable products. For example, cans of a particular type of soup may be fungible with respect to one another because any one can of the soup could be substituted with any other can of the soup. Non-fungible products may include products which are not readily interchangeable. For example, packaged chicken breast may be non-fungible because a customer may prefer one package over another because of differences in perceived quality, weight, packaging dates, and so forth.

In one example, multiple fungible products may correspond to a single one of the product tags 310. For example, 20 cans of soup may be placed on a shelving unit with a single product tag. In some examples, each non-fungible product may correspond to a respective label in addition to, or in lieu of, a single one of the product tags 310. For example, although 20 packages of chicken breast may be placed in a refrigeration unit with a single product tag of the product tags 310, which may include a product light-emitting component 316 and identify the products as packaged chicken breast, each of the packages of chicken breast may also include an additional label including package-specific information. Such package-specific information may include, for example, a weight and price of the specific package. Accordingly, the cameras 304 may be able to detect a specific weight and price of a product picked by the picker 104 by reading machine- and/or human-readable information on labels affixed to individual products as well as, or in lieu of, detecting information on the product tags 310.

In various examples, detecting that the picker 104 has picked a correct product and packed the product into a correct tote at act 508 may include the cameras 304 capturing visual information including the tote tags 308 and/or product tags 310. For example, the cameras 304 may capture product-identifying information (such as human-readable text and/or machine-readable bar codes or QR codes) displayed on the product display 318 to determine which product the picker 104 has picked. The cameras 304 may capture tote-identifying information (such as human-readable text and/or machine-readable bar codes or QR codes) to determine which tote the picker 104 has placed the product into. In other examples, the cameras 304 may identify products and/or totes by capturing images and/or video of the products and/or totes themselves, rather than or in addition to tag information, which may be input to one or more computer-vision algorithms to track products.

As discussed above, product inventory may be tracked based on visual information collected by the cameras 304. For example, when the cameras 304 observe a product being removed from the storage area 106 (for example, taken off of a shelf by the picker 104), the order-management system 302 may decrement a count of inventory for that product. When the cameras 304 observe a product being placed in the storage area 106 (for example, when being restocked or when the picker 104 replaces the product after determining that the product was incorrectly removed), the order-management system 302 may increment a count of inventory for that product.

In some examples, the order-management system 302 may control the tote light-emitting component 312 and the product light-emitting component 316 to emit light substantially simultaneously. In other examples, the order-management system 302 may control only one of the light-emitting components 312, 316 to emit light. For example, if the picker 104 only has a tote or totes for a single customer, it may not be critical that products are placed into particular totes. The order-management system 302 may therefore control only the product light-emitting component 316, and not the tote light-emitting component 312, to emit light to guide the picker 104. In other examples, the order-management system 302 may still control both the light-emitting components 312, 316 to emit light even if the picker 104 only has totes for a single customer. For example, if one of the totes 102 is a refrigerated tote and another of the totes 102 is a non-refrigerated tote, it may be desirable that refrigerated products are placed into a particular tote (for example, the refrigerated tote) and that non-refrigerated products are placed into a particular tote (for example, the non-refrigerated tote). Accordingly, in some examples, the order-management system 302 may control both the light-emitting components 312, 316 to emit light even if the picker 104 only has totes for a single customer.

An example of the foregoing principles is provided with respect to the process 500 for purposes of explanation. At act 502, the order-management system 302 receives three orders each from one of three customers, each order being for one or more products. The orders may be received at different times, but in close succession. The order-management system 302 may assign multiple orders in bulk to a single picker, but may wait to assign the orders to the picker 104 until enough orders have been received. For example, the order-management system 302 may wait until a total number of totes that are expected to be required to satisfy the orders exceeds five totes. For purposes of example, a first order from a first customer may be assigned three totes, a second order from a second customer may be assigned two totes, and a third order from a third customer may be assigned one tote. The order-management system 302 may then assign the three orders to the picker 104 responsive to determining that a total of six totes are to be used in satisfying the three orders.

At act 504, the order-management system 302 instructs the picker 104 to bring six of the totes 102 to a first product. The order-management system 302 may select the picker 104 because the picker 104 is not currently fulfilling an order, or will soon finish fulfilling an order. The order-management system 302 may instruct the picker 104 to select six specific totes which may be selected based on the contents of the three orders, such as by instructing the picker 104 to select a refrigerated tote to accommodate one or more products that require refrigeration. The order-management system 302 may provide control signals to the user communication device 306, which outputs an audio message to the picker 104 to aid the picker 104 in locating the correct totes. The order-management system 302 may also control tote light-emitting components 312 on the respective totes to output light to guide the picker 104 to the totes. The order-management system 302 may determine a desired sequence in which to acquire the products in the three orders and instruct, via the user communication device 306, the picker 104 to proceed to the first product in the sequence.

At act 506, the order-management system 302 activates the tote light-emitting component 312 and the product light-emitting component 316 corresponding to the product to be picked and the tote into which the product is to be packed. For example, the product may be a roll of bath tissue stocked on a shelf, and the order-management system 302 may control a light-emitting “bean” on a product tag affixed to the shelf below the bath tissue to blink yellow. The order-management system 302 may also control a light-emitting “bean” on one of the six totes to blink yellow to indicate that the picker 104 is to place the bath tissue in that tote.

The order-management system 302 may simultaneously activate a product light-emitting component 316 corresponding to another nearby product. For example, whereas the bath tissue may have been ordered by the first customer, the second customer may have ordered paper towels which are stocked on an adjacent section of the shelf from the bath tissue. The order-management system 302 may thus simultaneously control the product light-emitting component 316 corresponding to the paper towels to blink blue, and also control the tote light-emitting component 312 corresponding to a tote assigned to the second customer to blink blue.

At act 508, the cameras 304 capture the picker 104 correctly picking a roll of bath tissue and placing the bath tissue into the yellow-blinking tote corresponding to the first customer. The order-management system 302 may execute one or more computer-vision algorithms to detect this action. For example, the one or more computer-vision algorithms may include a movement-tracking feature to detect when the picker 104 removes the roll of bath tissue from a shelving unit and places the roll of bath tissue into a tote. The one or more computer-vision algorithms may also analyze a bar code or QR code on the product display 318 corresponding to the roll of bath tissue to detect that the picked product is a roll of bath tissue. The one or more computer-vision algorithms may also analyze a bar code or QR code on the tote display 314 to detect an identifier of the tote that the roll of bath tissue is placed into.

However, the cameras 304 may also capture the picker 104 picking a roll of paper towels and incorrectly placing the paper towels into the yellow-blinking tote corresponding to the first customer rather than the blue-blinking tote corresponding to the second customer. The order-management system 302 may control the user communication device 306 to provide feedback to the picker 104. For example, the user communication device 306 may output an audio message informing the picker 104 that the paper towels were placed into the incorrect tote, and should have been placed in the blue-blinking tote. Once the cameras 304 detect that the picker 104 has moved the paper towels to the correct tote (508 YES), the process 500 continues to act 510.

At act 510, the order-management system 302 determines that additional products from the three orders have yet to be picked and packed into the totes 102 (510 YES). Accordingly, the process 500 returns to act 504, and the order-management system 302 instructs the picker 104 to proceed to the next product. For example, the order-management system 302 may instruct the picker 104 to proceed to a certain product in a different aisle. Acts 504-510 are repeated until the order-management system 302 determines that all three customers' orders have been correctly packed into the totes 102 (510 NO), and the process 500 continues to act 512.

At act 512, the order-management system 302 instructs the picker 104 to drop off the six totes in the delivery area 108. The delivery area 108 may include ten dispatch lanes. Each dispatch lane may be staffed by at least one packager who removes the products from the totes 102 and packages the products in cardboard boxes. As noted above, the packager may be a robot that automatically packages the products. The order-management system 302 may instruct the picker 104 to drop off the three totes corresponding to the first customer in a first dispatch lane, to drop off the two totes corresponding to the second customer in a second dispatch lane, and to drop off the three totes corresponding to the third customer in a third dispatch lane. Each dispatch lane may include conveyor belts to convey the totes to a respective packager, who packages the products in cardboard boxes. The cardboard boxes may then be brought to a delivery vehicle. For example, the cardboard boxes may be moved by a shuttle robot and loaded onto a delivery truck. The delivery truck may then drive to an order-pickup area, such as a customer's home, package-storage-and-pickup lockers, a customer-facing section of a retail store, a package-pickup outpost, and so forth. The customer may then pick up the cardboard box at the order-pickup area.

The process 500 continues to act 514 to await the next order. Once the next order is received, the process 500 returns to act 502. As discussed above, the order-management system 302 may execute multiple instances of acts of the process 500 simultaneously. Furthermore, although acts of the process 500 are illustrated as occurring sequentially for purposes of explanation, the order-management system 302 may execute certain operations in parallel and/or repeatedly. For example, while the order-management system 302 is managing the fulfillment of one order at acts 504-512, the order-management system 302 may be aperiodically receiving additional orders at act 502.

The order-management system 302 may include at least one controller to execute various operations discussed above. Using data stored in associated memory and/or storage, the controller also executes one or more instructions stored on one or more non-transitory computer-readable media, which the controller may include and/or be coupled to, that may result in manipulated data. In some examples, the controller may include one or more processors or other types of controllers. In one example, the controller is or includes at least one processor. In another example, the controller performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A method of fulfilling product orders, the method comprising:
receiving an order for a plurality of products including a first product and a second product;
instructing a picker to bring at least one tote to the first product;
controlling at least one light-emitting component corresponding to at least one of the first product or the at least one tote to emit light to the picker;
determining that the picker has packed the first product in the at least one tote; and
instructing the picker to bring the at least one tote to the second product.

2. The method of claim 1, wherein the at least one tote includes a first tote and a second tote.

3. The method of claim 2, wherein the first tote includes a first light-emitting component and the second tote includes a second light-emitting component.

4. The method of claim 3, further comprising determining that the first product is to be packed in the first tote, and wherein controlling the at least one light-emitting component corresponding to the at least one of the first product or the at least one tote to emit light to the picker includes controlling the first light-emitting component to emit light.

5. The method of claim 4, wherein the first product is stored in a storage area having a third light-emitting component, and wherein controlling the at least one light-emitting component corresponding to the at least one of the first product or the at least one tote to emit light to the picker further includes controlling the third light-emitting component to emit light.

6. The method of claim 5, further comprising controlling the first light-emitting component and the third light-emitting component to emit light of the same color.

7. The method of claim 6, further comprising:
determining that the second product is to be packed in the second tote; and
controlling the second light-emitting component to emit light.

8. The method of claim 7, wherein the second product is stored in a storage area having a fourth light-emitting component, the method further comprising controlling both the second light-emitting component and the fourth light-emitting component to emit light.

9. The method of claim 8, further comprising controlling the second light-emitting component and the fourth light-emitting component to emit light of the same color.

10. The method of claim 1, further comprising:
receiving, from at least one camera, visual information indicative of the first product; and
determining, based on the visual information, that the picker has packed the first product in the at least one tote.

11. The method of claim 10, wherein determining that the picker has packed the first product in the at least one tote includes executing at least one computer-vision algorithm with respect to the visual information.

12. A non-transitory computer-readable medium storing thereon sequences of computer-executable instructions for fulfilling product orders, the sequences of computer-executable instructions including instructions that instruct at least one processor to:
receiving an order for a plurality of products including a first product and a second product;
instruct a picker to bring at least one tote to the first product;
control at least one light-emitting component corresponding to at least one of the first product or the at least one tote to emit light to the picker;
determine that the picker has packed the first product in the at least one tote; and
instruct the picker to bring the at least one tote to the second product.

13. The non-transitory computer-readable medium of claim 12, wherein the at least one tote includes a first tote having a first light emitting component and a second tote having a second light-emitting component, wherein the instructions further instruct the at least one processor to determine that the first product is to be packed in the first tote, and wherein controlling the at least one light-emitting component corresponding to the at least one of the first product or the at least one tote to emit light to the picker includes controlling the first light-emitting component to emit light.

14. The non-transitory computer-readable medium of claim 13, wherein the first product is stored in a storage area having a third light-emitting component, and wherein controlling the at least one light-emitting component corresponding to the at least one of the first product or the at least one tote to emit light to the picker further includes controlling the third light-emitting component to emit light.

15. The non-transitory computer-readable medium of claim 14, wherein the instructions further instruct the at least one processor to control the first light-emitting component and the third light-emitting component to emit light of the same color.

16. The non-transitory computer-readable medium of claim 15, wherein the instructions further instruct the at least one processor to:
determine that the second product is to be packed in the second tote; and
control the second light-emitting component to emit light.

17. The non-transitory computer-readable medium of claim 16, wherein the second product is stored in a storage area having a fourth light-emitting component, and wherein the instructions further instruct the at least one processor to control both the second light-emitting component and the fourth light-emitting component to emit light.

18. The non-transitory computer-readable medium of claim 17, wherein the instructions further instruct the at least one processor to control the second light-emitting component and the fourth light-emitting component to emit light of the same color.

19. The non-transitory computer-readable medium of claim 12, wherein the instructions further instruct the at least one processor to:
receive, from at least one camera, visual information indicative of the first product; and
determine, based on the visual information, that the picker has packed the first product in the at least one tote.

20. The non-transitory computer-readable medium of claim 19, wherein determining that the picker has packed the first product in the at least one tote includes executing at least one computer-vision algorithm with respect to the visual information.

21. An order-fulfillment system comprising:
one or more cameras;
at least one user communication device corresponding to a picker;
at least one tote, each tote having at least one tote light-emitting component;
a plurality of products including a first product and a second product, each product corresponding to at least one product light-emitting component; and
at least one order-management controller configured to:
instruct the picker to bring the at least one tote to the first product;
control at least one of the at least one tote light-emitting component or the product light-emitting component to emit light to the picker;
determine that the picker has packed the first product in the at least one tote; and
instruct the picker to bring the at least one tote to the second product.
